(19) United States
(12) Patent Application Publication
(10) Pub. No.: US 2025/0265785 A1
(43) Pub. Date: Aug. 21, 2025

(54) Augmented Reality Threat Indicator Overlay

(71) Applicant: Naval Information Warfare Center Pacific, San Diego, CA (US)

(72) Inventor: Stephen T Pease, La Mesa, CA (US)

(73) Assignee: THE UNITED STATES OF AMERICA AS REPRESENTED BY THE SECRETARY OF THE NAVY, San Diego, CA (US)

(21) Appl. No.: 18/442,383

(22) Filed: Feb. 15, 2024

(51) Int. Cl. G06T 19/00; G06F 1/16; G06V 10/776

(52) U.S. Cl. CPC G06T 19/006; G06V 10/776; G06F 1/163; G06T 2219/004

(57) ABSTRACT

A system with an augmented reality threat indicator overlay includes a high-performance computing center, one or more data collection devices, and one or more augmented reality devices. The high-performance computing center, one or more data collection devices, and one or more augmented reality devices each have a transceiver capable of sending and receiving data to each other. The high-performance computing center includes one or more computer processors capable of machine learning to continuously update a threat prediction model and a storage device capable of storing instructions and the data. The one or more data collection devices gather the data and send the data to and from the high-performance computing center. The one or more augmented reality devices include an augmented reality display that is capable of overlaying a threat indicator percentage on a threat.

### STATEMENT REGARDING FEDERALLY SPONSORED RESEARCH OR DEVELOPMENT

The invention described herein may be manufactured and used by or for the government of the United States of America for governmental purposes without the payment of any royalties thereon or therefor. Licensing and technical inquiries may be directed to the Office of Research and Technical Applications, Naval Information Warfare Center Pacific, Code 72120, San Diego, CA, 92152; (619) 553-5118; NIWC_Pacific_T2@us.navy.mil. Reference Navy Case Number 114322.

### BACKGROUND

Augmented reality is a combination of the real-world and computer generated content typically shown through a device worn by a user that displays the computer generated content in combination with the real-world. The devices can be worn, such as glasses or goggles, a handheld device, such as a display that is held by the user, or projected by a device. Augmented reality has numerous applications including education, training, navigation, and a variety of social applications. Augmented reality can also be used in military applications to aid different military personnel with information about the battlefield.

### DESCRIPTION OF THE DRAWINGS

Features and advantages of examples of the present disclosure will be apparent by reference to the following detailed description and drawings, in which like reference numerals correspond to similar, but in some instances, not identical, components. Reference numerals or features having a previously described function may or may not be described in connection with other drawings in which they appear.

FIG. 1 is an example of the system described herein with four different types of data collection devices;

FIG. 2 is another example of the system described herein using a handheld or mounted camera as the data collection device;

FIG. 3 is another example of the system described herein using a drone camera as the data collection device;

FIG. 4 is another example of the system described herein using a satellite camera as the data collection device;

FIG. 5 is another example of the system described herein using a satellite camera and a drone camera as the data collection devices;

FIG. 6A-6B are examples of a threat without and with the threat indicator overlay shown as a threat indicator percentage overlaying a threat, respectively; and

FIG. 7 is an example of a method of displaying an augmented reality threat indicator overlay.

### DETAILED DESCRIPTION

Currently, military augmented reality systems exist that track threats and objects using devices built into helmets that are worn by soldiers. There are also land, air, and sea vehicles that use augmented reality to provide information about the battlefield, which may include tracking different targets or objects. However, none of the current systems include continuously updating systems in real-time to identify and display threats via a threat percentage overlay in the augmented reality display. In current displays, augmented reality systems display an icon to show or track a possible threat. However, current systems do not identify the likelihood of a threat or update the likelihood of a threat in real-time.

In the system herein, the likelihood of a threat is identified by overlaying a threat percentage on any possible threat. This is accomplished by using a high-performance computing center with a threat prediction model that is continuously updated via machine learning. Data collection devices send data from the battlefield to the high-performance computing center, which uses the data to update the threat prediction model. The high-performance computing center or the data collection device can send information on a threat to a user using an augmented reality device in the form of a threat indicator percentage to show whether a person, object, structure, etc. is a threat. In contrast to current systems, rather than flooding a user with too much information (e.g., tracking every potential target), a threat indicator percentage is overlaid on a threat that is updated in real-time.

The system with an augmented reality threat indicator overlay includes a high-performance computing center, one or more data collection devices, and one or more augmented reality devices. The high-performance computing center includes one or more computer processors capable of machine learning to continuously update a threat prediction model, a storage device capable of storing instructions and data, and a high-performance computing center transceiver capable of sending and receiving the data. The one or more data collection devices gather the data and each include a collection device transceiver that is capable of sending and receiving the data that to and from the high-performance computing center. The one or more augmented reality devices include an augmented reality display that is capable of overlaying a threat indicator percentage on a threat and an augmented reality device transceiver capable of transmitting and receiving the data from the high-performance computing center or the one or more data collection devices to update the threat indicator percentage in real-time.

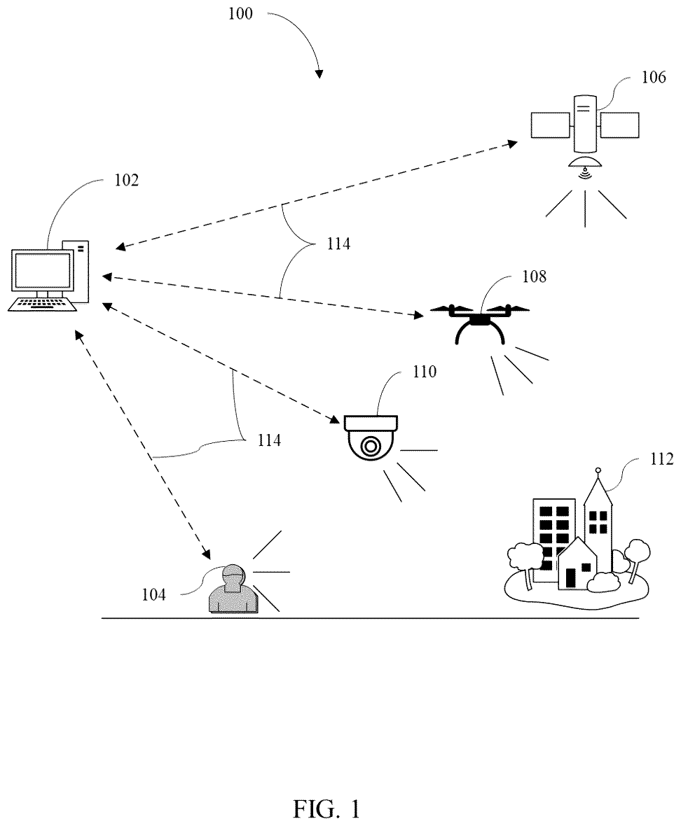

Referring now to FIG. 1, the augmented reality threat overlay system 100 includes a high-performance computing center 102. The high-performance computing center 102 includes one or more computer processors capable of machine learning to continuously update a threat prediction model. The threat prediction model may be any known software capable of continuously undergoing machine learning. The threat prediction model is formed using supervised training, unsupervised training, or a combination thereof. In an example, the supervised training is data that is input into the threat prediction model that either shows a threat or does not show a threat and the determination of the threat prediction model is verified to ensure accuracy. In another example, unsupervised training is data that is input into the threat prediction model and the threat prediction model automatically determines whether that data shows a threat or does not show a threat. In an example, the supervised training or unsupervised training is performed with verified or unverified data from the one or more data collection devices. In another example, the supervised training or unsupervised training is performed with data from any known source. In another example, the threat prediction model can be programmed and updated using iterative learning based on the accuracy of the threat percentage from feedback by individuals in the field (i.e., an example of verified data).

The high-performance computing center 102 also includes a storage device capable of storing instructions and data and a high-performance computing center transceiver capable of sending and receiving the data. The instructions include software to continuously run the threat prediction model. The high-performance computing center transceiver allows the high-performance computing center 102 to receive data via a wireless medium 114 from the one or more collection devices or the augmented reality device 104 of one or more potential threats in real-time or any other source sending data to the high-performance computing center 102. The high-performance computing center 102 can then run the data through the threat prediction model and determine a threat percentage to overlay on the threat. The high-performance computing center transceiver then allows the high-performance computing center 102 to transmit the threat percentage overlay, via the wireless medium 114, of the threat to the one or more data collection devices, one or more augmented reality devices, or a combination thereof. The high-performance computing center 102 continuously performs this function in real-time as the one or more data collection devices or the one or more augmented reality devices 104 gather more information on a threat or encounter a new threat.

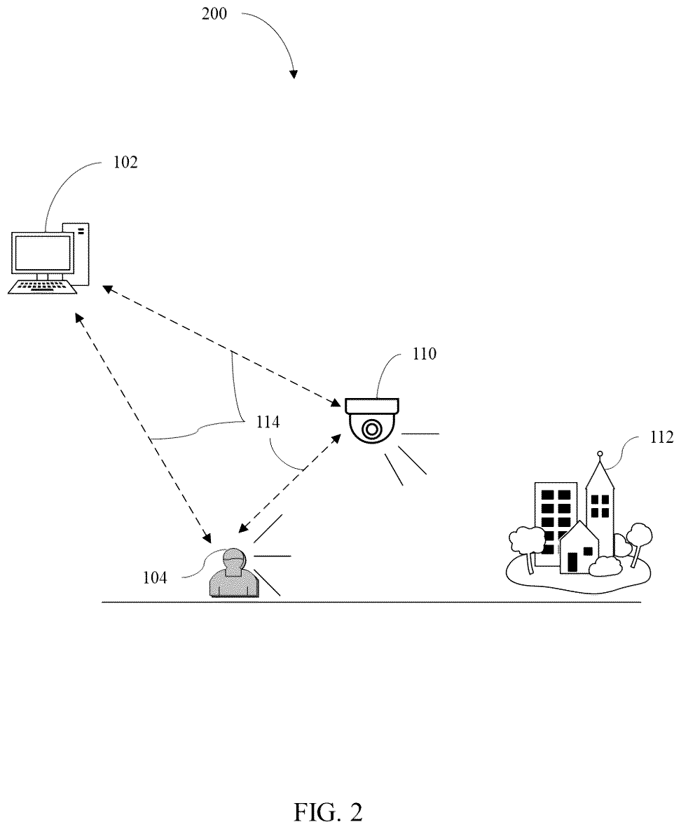

Referring back to FIG. 1, the augmented reality threat overlay system 100 includes one or more collection devices. In the example shown in FIG. 1, the one or more collection devices include an augmented reality device 104 with a camera, a hand-held or fixed camera 110 (e.g., a 360° handheld camera), a drone 108 with a camera, a satellite 106 with a camera, or a combination thereof. The one or more data collection devices gather data and each include a data collection device transceiver that is capable of sending and receiving the data to and from the high-performance computing center 102 as shown in FIG. 1. The one or more data collection devices are capable of sending and receiving data indirectly to the high-performance computing center 102 by sending or receiving data to or from other data collection devices. For example, a satellite 106 may send or receive data to an augmented reality device 104, which may send data to the high-performance computing center 102. This is discussed in reference to FIG. 2-FIG. 5. The data includes one or more images, one or more videos, one or more live video feeds, or a combination thereof from the one or more data collection devices or any other known source imported into the augmented reality threat overlay system 100. The data includes one or more images, one or more videos, one or more live video feeds, or a combination thereof of a threat or potential threat 112 obtained by the one or more data collection devices. The threat or potential threat 112 may be an individual, a vehicle, a device or object, an aerial vehicle, a structure, or a combination thereof.

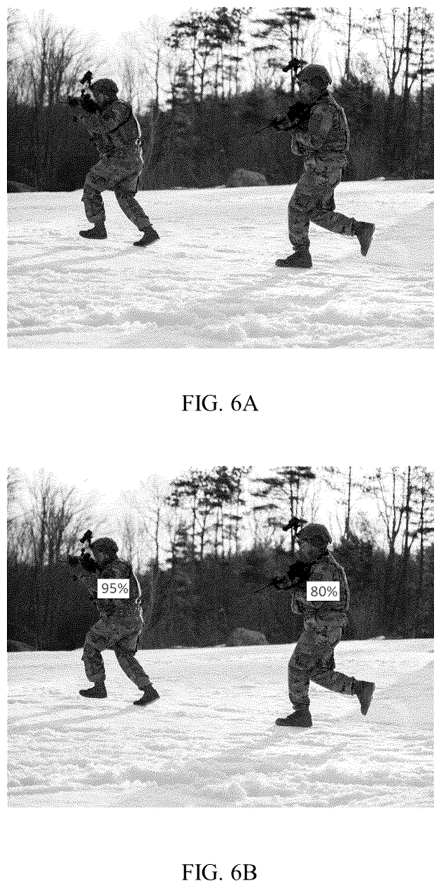

Referring back to FIG. 1, the augmented reality threat overlay system 100 includes one or more augmented reality devices 104. The one or more augmented reality devices 104 include an augmented reality display that is capable of overlaying a threat indicator percentage on a threat or potential threat 112. An example of the threat indicator percentage is shown in FIG. 6B. FIG. 6A shows an example of potential threats and FIG. 6B shows the threat indicator percentage overlaid on the threat or potential threat 112. Each augmented reality device 104 includes an augmented reality transceiver capable of transmitting and receiving data from the high-performance computing center 102 or the one or more data collection devices (104, 106, 108, 110) to update the threat indicator percentage in real-time. In the example shown in FIG. 1, the one or more augmented reality devices 104 may be a wearable augmented reality device 104, such as goggles, glasses, or a visor. In another example, the one or more augmented reality devices 104 may be a translucent tablet. In some examples, the one or more augmented reality devices 104 can also function as the one or more data collection devices by using a camera on each augmented reality device 104 to gather data and transmit that data to the high-performance computing center 102 or another data collection device. Similarly, the one or more augmented reality devices 104 may transmit verified data of the threat or potential threat 112 indirectly through the one or more data collection devices or directly to the high-performance computing center 102. An example of the verified data includes an individual verifying whether a potential threat was in fact a threat and transmitting that information to the high-performance computing center 102.

Referring now to FIG. 2, another example of the augmented reality threat overlay system 200 is shown. In this example, the system 200 includes a hand-held or fixed camera 110 and an augmented reality device 104 with a camera. The hand-held or fixed camera 110 and the augmented reality device 104 are wirelessly connected via the wireless medium 114 to each other and the high-performance computing center 102 to gather data on the threat or potential threat 112. In one example, the high-performance computing center 102 can analyze the data via the threat prediction model, provide verified data via the wireless medium 114 of the threat as a threat percentage overlay indirectly through the hand-held or fixed camera 110, and then transmit the data from the hand-held camera or fixed camera 110 to the augmented reality device 104. In another example, the high-performance computing center 102 can analyze the data via the threat prediction model and provide verified data via the wireless medium 114 of the threat as a threat percentage overlay directly to the augmented reality device 104. In some examples, the augmented reality device 104 can wirelessly transfer verified data of the threat or potential threat 112 directly or indirectly to the high-performance computing center 102 once the threat or potential threat 112 is determined as an actual threat or no threat. In some examples, the high-performance computing device 104 may share the verified data or threat percentage overlay with other augmented reality devices 104 such that when the other augmented reality devices 104 view the threat or potential threat 112, the threat overlay percentage appears.

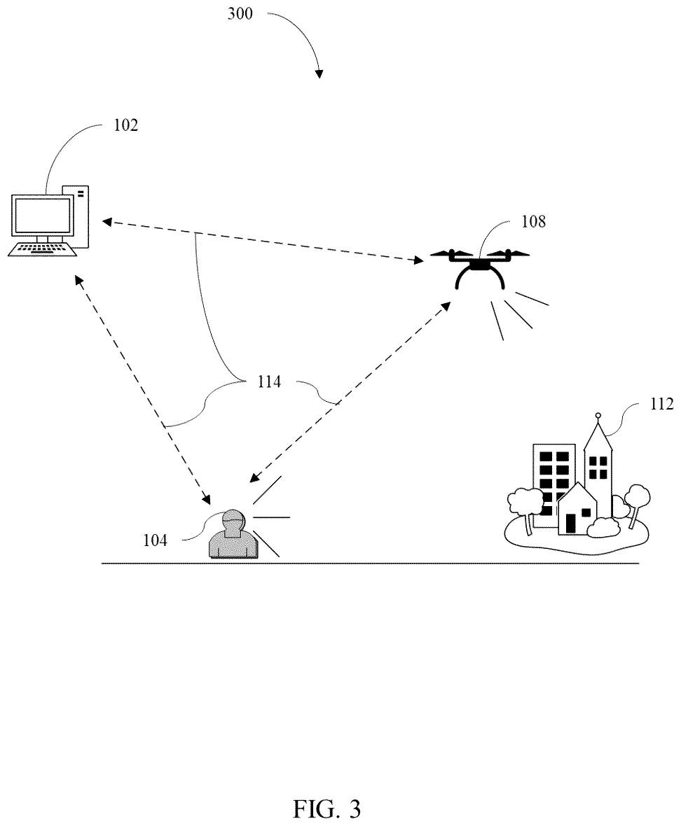

Referring now to FIG. 3, another example of the augmented reality threat overlay system 300 is shown. In this example, the system 300 includes a drone 108 with a camera and an augmented reality device 104 with a camera. The drone 108 with a camera and the augmented reality device 104 are wirelessly connected to each other and the high-performance computing center 102 via the wireless medium 114 to gather data on the threat or potential threat 112. In one example, the high-performance computing center 102 can analyze the data via the threat prediction model, provide verified data via the wireless medium 114 of the threat as a threat percentage overlay indirectly through the drone 108, and then transmit the data from the drone 108 to the augmented reality device 104. In another example, the high-performance computing center 102 can analyze the data via the threat prediction model and provide verified data via the wireless medium 114 of the threat as a threat percentage overlay directly to the augmented reality device 104. In some examples, the augmented reality device 104 can wirelessly transfer verified data of the threat or potential threat 112 directly or indirectly to the high-performance computing center 102 once the threat or potential threat 112 is determined as an actual threat or no threat. In some examples, the high-performance computing device 102 may share the verified data or threat percentage with other augmented reality devices 104 such that when the other augmented reality devices 104 view the threat or potential threat 112, the threat overlay percentage appears.

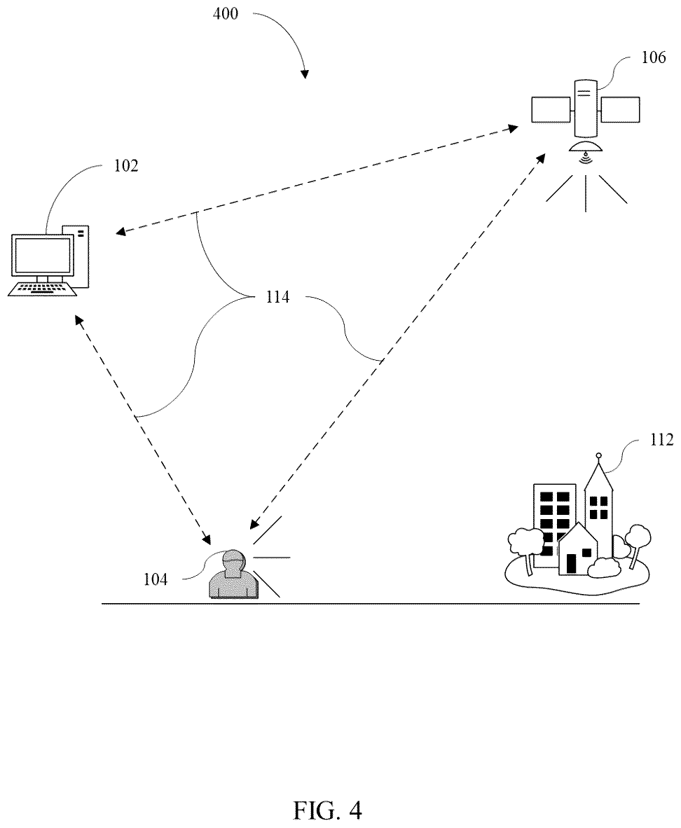

Referring now to FIG. 4, another example of the augmented reality threat overlay system 400 is shown. In this example, the system 400 includes a satellite 106 with a camera and an augmented reality device 104 with a camera. The satellite 106 with a camera and the augmented reality device 104 are wirelessly connected to each other and the high-performance computing center 102 via the wireless medium 114 to gather data on the threat or potential threat 112. The high-performance computing center 102 can analyze the data via the threat prediction model, provide analysis data via the wireless medium 114 of the threat as a threat percentage indirectly through the satellite 106, and then transmit the analysis data from the satellite 106 to the augmented reality device 104 or directly to the augmented reality device 104. In some examples, the augmented reality device 104 can wirelessly transfer verified data of the threat or potential threat 112 directly or indirectly to the high-performance computing device 102 once the threat or potential threat 112 is determined as an actual threat or no threat. In some examples, the high-performance computing center 102 may share the verified data or threat percentage with other augmented reality devices 104 such that when the other augmented reality devices 104 being used at viewing the threat or potential threat 112, the threat overlay percentage appears.

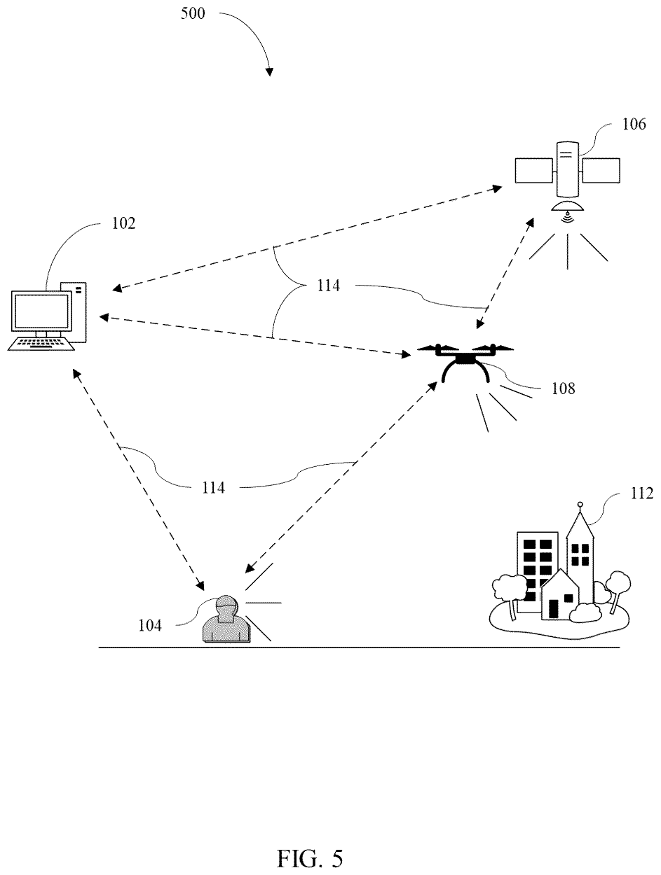

Referring now to FIG. 5, another example of the augmented reality threat overlay system 500 is shown. In this example, the system 500 includes a drone 108 with a camera, a satellite 106 with a camera, and an augmented reality device 104 with a camera. The drone 108, the satellite 106, and the augmented reality device 104 are wirelessly connected to each other via the wireless medium 114 and the high-performance computing center 102 to gather data on the threat or potential threat 112. In one example, the high-performance computing center 102 can analyze the data via the threat prediction model, provide analysis data via the wireless medium 114 of the threat as a threat percentage indirectly through the drone 108, the satellite 106, or both, and then transmit the analysis data from the drone 108, satellite 106, or both to the augmented reality device 104. In another example, the high-performance computing center 102 can analyze the data via the threat prediction model and provide analysis data via the wireless medium 114 of the threat as a threat percentage directly to the augmented reality device 104. In some examples, the augmented reality device 104 can wirelessly transfer verified data of the threat or potential threat 112 directly or indirectly to the high-performance computing center 102 once the threat or potential threat 112 is determined as an actual threat or no threat. In some examples, the high-performance computing device 102 may share the verified data or threat percentage with other augmented reality devices 104 such that when the other augmented reality devices 104 being used at viewing the threat or potential threat 112, the threat overlay percentage appears.

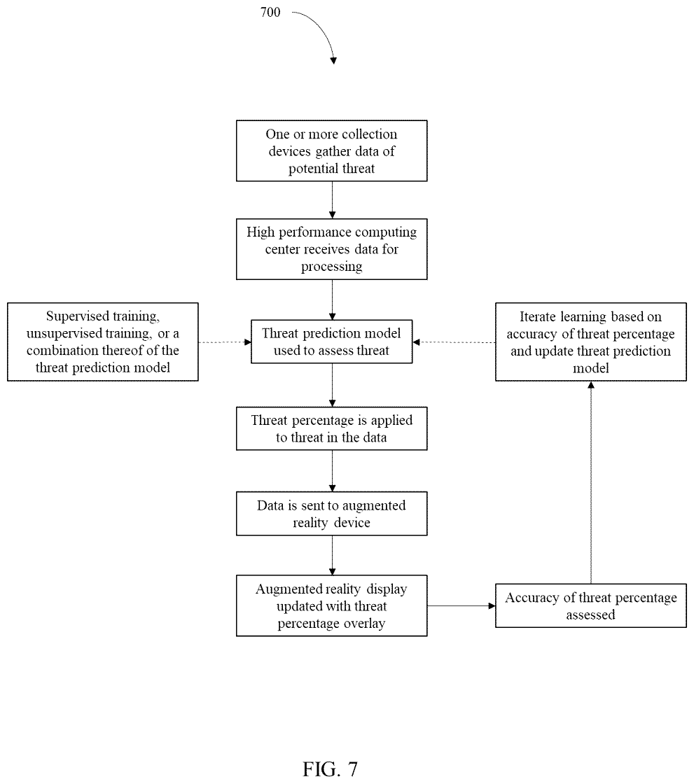

Referring now to FIG. 7, an example of a method of displaying an augmented reality threat indicator overlay 700 is shown. First, the method includes programming a high-performance computing center that includes computer processors with a storage device capable of storing instructions and data, and a high-performance computing center transceiver capable of sending and receiving the data. The high-performance computing center is programmed using machine learning to continuously update a threat prediction model. The threat prediction model is formed using supervised training, unsupervised training, or a combination thereof as shown in FIG. 7. In an example, the supervised training or unsupervised training is performed with verified or unverified data from the one or more data collection devices. In another example, the supervised or unsupervised training may be performed with verified data (i.e., data of an actual threat or no threat). In another example, the threat prediction model can be programmed and updated using iterative learning based on the accuracy of the threat percentage from feedback by individuals in the field (i.e., an example of verified data).

Once the threat prediction model is programmed into the high-performance computing center, one or more data collection devices gather data. The one or more data collection devices each include a collection device transceiver that is capable of sending and receiving the data to and from the high-performance computing center. Some examples of the one or more data collection devices include an augmented reality with a camera, a hand-held or fixed camera, a drone with a camera, a satellite with a camera, or a combination thereof. The data that is gathered may be one or more images, one or more videos, one or more live video feeds, or a combination thereof of potential threats or threats. Some examples of the threats include an individual, a vehicle, a device or object, an aerial vehicle, a structure, or a combination thereof. In the example shown in FIG. 7, the one or more collection devices gather data of a potential threat and send that data via the collection device transceiver to the high-performance computing center. The high-performance computing center processes that data via the threat prediction model and applies a threat percentage to the threat in the data. The threat percentage data is then sent to one or more augmented reality devices via the high-performance computing center transceiver and displayed as a threat percentage overlay on the threat.

Once the data is gathered, analyzed, and sent to the one or more augmented reality devices, the threat indicator percentage is overlaid on the threat via the augmented reality device. Each augmented reality device includes an augmented reality display that is capable of overlaying the threat indicator percentage on the threat and an augmented reality device transceiver capable of transmitting and receiving the data from the high performance computing center or the one or more data collection devices to update the threat indicator percentage in real-time. Some examples of the one or more augmented reality devices include goggles, glasses, a translucent tablet, or a visor. The accuracy of the threat percentage overlay may be assessed and verified. The augmented reality device transmits verified data of the threat indirectly or directly to the high-performance computing center. The verified data may be used to iterate the learning and update the threat prediction model based on the accuracy of the threat percentage as shown in FIG. 7 for future threats. In some examples, the high-performance computing center transmits verified data of the threat to the one or more data collection devices, additional augmented reality devices, or a combination thereof.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of a list should be construed as a de facto equivalent of any other member of the same list merely based on their presentation in a common group without indications to the contrary.

Unless otherwise stated, any feature described herein can be combined with any aspect or any other feature described herein.

Reference throughout the specification to “one example”, “another example”, “an example”, means that a particular element (e.g., feature, structure, and/or characteristic) described in connection with the example is included in at least one example described herein, and may or may not be present in other examples. In addition, the described elements for any example may be combined in any suitable manner in the various examples unless the context clearly dictates otherwise.

The ranges provided herein include the stated range and any value or sub-range within the stated range. For example, a range from about 0.1 to about 20 should be interpreted to include not only the explicitly recited limits of from about 0.1 to about 20, but also to include individual values, such as 3, 7, 13.5, etc., and sub-ranges, such as from about 5 to about 15, etc.

In describing and claiming the examples disclosed herein. the singular forms “a”, “an”, and “the” include plural referents unless the context clearly dictates otherwise.

What is claimed is:

1. A system with an augmented reality threat indicator overlay, comprising:
a high-performance computing center, wherein the high-performance computing center includes one or more computer processors capable of machine learning to continuously update a threat prediction model, a storage device capable of storing instructions and data, and a high-performance computing center transceiver capable of sending and receiving the data;
one or more data collection devices, wherein the one or more data collection devices gather the data and each include a collection device transceiver that is capable of sending and receiving the data to and from the high-performance computing center;
one or more augmented reality device, wherein the each augmented reality device includes an augmented reality display that is capable of overlaying a threat indicator percentage on a threat and an augmented reality device transceiver capable of transmitting and receiving the data from the high-performance computing center or the one or more data collection devices to update the threat indicator percentage in real-time.

2. The system of claim 1, wherein the threat prediction model is formed using supervised training, unsupervised training, or a combination thereof.

3. The system of claim 1, wherein the one or more data collection devices include an augmented reality device with a camera, a hand-held or fixed camera, a drone with a camera, a satellite with a camera, or a combination thereof.

4. The system of claim 1, wherein the data includes one or more images, one or more videos, one or more live video feeds, or a combination thereof.

5. The system of claim 1, wherein the threat is an individual, a vehicle, a device or object, an aerial vehicle, a structure, or a combination thereof.

6. The system of claim 1, wherein the one or more augmented reality devices are goggles, glasses, a translucent tablet, or a visor.

7. The system of claim 2, wherein the supervised training or unsupervised training is performed with verified or unverified data from the one or more data collection devices.

8. The system of claim 2, wherein the supervised training or unsupervised training is performed with verified data.

9. The system of claim 1, wherein the one or more augmented reality devices transmit verified data of the threat indirectly or directly to the high-performance computing center.

10. The system of claim 9, wherein the high-performance computing center transmits verified data of the threat to the one or more data collection devices, one or more augmented reality devices, or a combination thereof.

11. A method of displaying an augmented reality threat indicator overlay, comprising:
programming a high-performance computing center that includes computer processors with a storage device capable of storing instructions and data, and a high-performance computing center transceiver capable of sending and receiving the data, wherein the high-performance computing center is programmed using machine learning to continuously updates a threat prediction model;
gathering the data via one or more data collection devices, wherein the one or more data collection devices each include a collection device transceiver that is capable of sending and receiving the data to and from the high-performance computing center; and
overlaying a threat indicator percentage on a threat via one or more augmented reality devices, wherein each augmented reality device includes an augmented reality display that is capable of overlaying the threat indicator percentage on the threat and an augmented reality device transceiver capable of transmitting and receiving the data from the high-performance computing center or the one or more data collection devices to update the threat indicator percentage in real-time.

12. The method of claim 11, wherein the threat prediction model is formed using supervised training, unsupervised training, or a combination thereof.

13. The method of claim 11, wherein the one or more data collection devices include an augmented reality device with a camera, a hand-held or fixed camera, a drone with a camera, a satellite with a camera, or a combination thereof.

14. The method of claim 11, wherein the data includes one or more images, one or more videos, one or more live video feeds, or a combination thereof.

15. The method of claim 11, wherein the threat is an individual, a vehicle, a device or object, an aerial vehicle, a structure, or a combination thereof.

16. The method of claim 11, wherein the augmented reality device is goggles, glasses, a translucent tablet, or a visor.

17. The method of claim 12, wherein the supervised training or unsupervised training is performed with verified or unverified data from the one or more data collection devices.

18. The method of claim 12, wherein the supervised training or unsupervised training is performed with verified data.

19. The method of claim 11, wherein the one or more augmented reality devices transmit verified data of the threat indirectly or directly to the high-performance computing center.

20. The method of claim 19, wherein the high-performance computing center transmits verified data of the threat to the one or more data collection devices, one or more augmented reality devices, or a combination thereof.
